(19) United States
(12) Patent Application Publication
(10) Pub. No.: US 2025/0198175 A1
(43) Pub. Date: Jun. 19, 2025

(54) ELEVATING FALL PROTECTION CAGE SYSTEM ACCOMMODATIVE OF MULTIPLE TYPES OF BULK TRANSPORT CONTAINERS

(71) Applicant: Sam Carbis Asset Management, LLC, Florence, SC (US)

(72) Inventors: Allyn Thomasson, Darlington, SC (US); Joshua Graham, Florence, SC (US); Ellie H. MacDonald, Timmonsville, SC (US)

(21) Appl. No.: 18/984,066

(22) Filed: Dec. 17, 2024

Related U.S. Application Data
(60) Provisional application No. 63/611,330, filed on Dec. 18, 2023.

(51) Int. Cl. E04G 1/20; E04G 5/14

(52) U.S. Cl. CPC E04G 1/20; E04G 5/14

(57) ABSTRACT

A worker protection cage that is deployed from above a bulk transport container and helps guard against workers falling from the container includes an elevating platform, which in turn includes a base frame. A lift mechanism carries the base frame and selectively raises and lowers the base frame, which carries a floor that includes a plurality of floor extensions that are moveable to change the area covered by the floor. A lateral extender is coupled to the base frame. A fence is pivotally coupled to the lateral extender. Each of a front cage and back cage is carried by the base frame and includes a swing gate that controls access to the respective cage.

### TECHNICAL FIELD

The invention relates to the type of worker protection cage that is deployed from above a bulk transport container and helps guard against workers falling from the container.

### BACKGROUND OF THE INVENTION

It is necessary to provide workers with access to various work areas at the tops of rolling stock such as tank cars, which are used to transport flowing materials that typically are in liquid form but occasionally in granular form. As these tank cars are cylindrical in shape, the tops of these tank cars are curved, making for curved surfaces on which workers must maintain their balance when accessing various work areas. Though some work areas are provided with level platforms, because flowing materials are involved, even work areas with such level platforms often include slippery surfaces on which the workers must tread when carrying out their assigned duties. Various weather conditions such as rain, sleet, snow and ice also can impose and/or exacerbate slippery surfaces that can cause workers to slip and fall when carrying out their assigned duties. Thus, these work areas typically are furnished with some sort of railing structure that runs the length and width of the work area at the top of the rolling stock. However, these railing structures typically are inadequate to prevent workers from falling to the ground after slipping through one of the openings in the railing structures or tumbling over the top of the railing structures.

Before workers are permitted to access the tops of rolling stock (tank trucks, tank railroad cars, etc.), a cage can be deployed surrounding the portion of the top of the rolling stock where the workers are to be engaged in their duties. Examples of these sorts of safety cages can be found in U.S. Pat. Nos. 7,216,741; 8,479,884; 8,403,109; 8,479,882; 6,405,831; 4,679,657; 9,409,755; each of which being hereby incorporated in its entirety herein by this reference for all purposes. As disclosed in U.S. Pat. No. 4,679,657, an inboard end of a gangway can be pivotally connected to a walkway that is fixed at a stationary height above the work area, and the gangway can be pivotally deployed so that its outboard end can be selectively raised and lowered with respect to the top of the work area. As disclosed in U.S. Pat. No. 8,479,882, a rectilinear cage is deployed from the outboard end of the gangway, and the cage includes a section that is provided with flooring on which workers can walk adjacent an open section without flooring. As disclosed in U.S. Pat. No. 9,228,364, which is hereby incorporated in its entirety herein by this reference for all purposes, the area inside the cage covered by the walkable section can be provided at different heights, and the open section without flooring inside the cage can be provided in different shapes.

Each cage typically assumes the shape of a rectangular box having contiguous pairs of the sides connected to each other in what is essentially a right angle. In some embodiments, the corners of each cage can be curved rather than a sharp right angle. Conventionally, the cage's side that is disposed closest to the structure from which the cage is deployed will be considered the inboard side of the cage. Similarly, the cage's side that is disposed farthest away from the structure from which the cage is deployed will be considered the outboard side. One of the opposite ends of the front of the cage is connected to the inboard side while the other opposite end of the front of the cage is connected to the outboard side of the cage. Similarly, one of the opposite ends of the back of the cage is connected to the inboard side while the other opposite end of the back of the cage is connected to the outboard side of the cage.

However, as depicted in U.S. Pat. Nos. 9,133,014 and 8,051,951, which are hereby incorporated in their entireties herein by this reference for all purposes, because of the presence of the railing structure, such cages remain above the top handrails and fail to provide any fall protection deployed beneath the top handrails of the railing structure. As a result, the openings beneath the top handrail can range between 22 and 30 inches and thus remain big enough for a person to slip through, thereby failing to provide adequate worker fall protection. Moreover, these cages resting on the top handrails of the railing structure typically are small (on the order of a foot tall above the handrail). Some cage structures are more elaborate and require expensive subsystems that must be activated before it is deemed safe for workers to access the work areas on the tops of the rolling railing stock. However, improper activation of these subsystems renders them less effective, and thus these subsystems require the presence of workers who are trained to operate such subsystems.

Because the railing structures atop the tanks come in a variety of different configurations, it is difficult to match the cage configuration with the railing structure in a way that ensures fall protection for the workers engaged in their duties at the particular section of the top of the rolling stock where these worker duties are to be carried out. Having to stockpile different cages with different configurations in anticipation of satisfying the requirements of many different configurations for the railing structures is so problematical as to be economically not feasible. Moreover, the worker's duties involve tasks that sometimes must be performed when the rolling stock is parked in different sorts of environments that affect the best way for these cages to be deployed to address the particular location atop the loading stock where such worker tasks are to be performed. Even so, having personnel on hand who are sufficiently competent to manipulate the cages appropriately with respect to the environments where the loading stock is parked and with respect to the configuration of the various railing structures also poses problems. Less competent personnel take longer to deploy the cages, and securing personnel sufficiently competent to deploy the cages can delay the performance of the tasks and tie up loading sites while the requisite personnel are secured. Such delays add additional cost to the performance of these tasks.

As disclosed in U.S. Pat. No. 9,409,755, which is hereby incorporated in its entirety herein by this reference for all purposes, more elaborate cages can be vertically disposed at desired elevations while maintaining the flooring sections horizontal. Moreover, the flooring sections are pivotable to permit adjustments in both the positioning and the sizing of the open section without flooring. However, the flooring sections must be manually lowered from their vertically upright stored orientations to their horizontal flooring orientations, thereby subjecting the workers both handling risk and falling risk.

As disclosed in U.S. Pat. No. 10,457,506, which is hereby incorporated in its entirety herein by this reference for all purposes, cages lacking any flooring sections have been provided with an outboard fencing section that is pivotable to permit adjustments in the open area of the cage along the length of the outboard fencing section.

Accordingly, a need exists for apparatus that addresses these issues raised above in a manner that is uncomplicated, reliable and minimizes the need for special worker training.

### OBJECTS AND SUMMARY OF THE INVENTION

Therefore, it is an object of the present invention to disclose an elevating platform that is capable of being reconfigured to provide fall protection to workers dealing with multiple types of vehicles carrying cargo bulk cargo.

### BRIEF DESCRIPTION OF THE SEVERAL VIEWS OF EXEMPLARY DRAWINGS

In the following, the invention will be explained in more detail by means of exemplary embodiments thereof referring to the figures in which:

FIG. 1 shows an isometric perspective view of a presently preferred embodiment of the present invention;

FIG. 2 shows a plan view from above the embodiment of FIG. 1;

FIG. 3 shows an end elevation view from one end of the embodiment of FIG. 1 with the outboard section disposed in a retracted mode of operation;

FIG. 4 shows an isometric perspective view of components of a presently preferred embodiment of the present invention, wherein the components have been partially disassembled for ease of reference;

FIG. 4A shows an isometric perspective view of components of a presently preferred embodiment of the lifting mechanism of the present invention;

FIG. 4B shows an isometric perspective view of components of a presently preferred embodiment of the lifting mechanism of the present invention;

FIG. 4C shows an isometric perspective view of components of a presently preferred embodiment of the lifting mechanism of the present invention;

FIG. 5 shows an end elevation view from the same end of the embodiment of FIG. 1 as shown in FIG. 3 but configured with the outboard section disposed in an extended mode of operation;

FIG. 6 shows an isometric perspective view of components of a partial section of a presently preferred embodiment of the present invention;

FIG. 7 shows a perspective view of a section of a disassembled component of an embodiment of the present invention;

FIG. 8 shows a perspective view of a section of a disassembled component of an embodiment of the present invention;

FIG. 9 shows a partial elevation end view from one end of the embodiment shown in FIG. 3 with the outboard section disposed in a retracted mode of operation;

FIG. 10 shows an isometric perspective view of components of a presently preferred embodiment of the present invention;

FIG. 10A shows a top plan view of the component shown in FIG. 10;

FIG. 10B shows a side plan view of the component shown in FIG. 10;

FIG. 10C shows a rear view of the component shown in FIG. 10;

FIG. 11 shows an isometric perspective view of components of a presently preferred embodiment of the present invention;

FIG. 11A shows a top plan view of the component shown in FIG. 11;

FIG. 11B shows a side plan view of the component shown in FIG. 11;

FIG. 11C shows a rear view of the component shown in FIG. 11;

FIG. 12 shows an isometric perspective view of a presently preferred embodiment of the present invention deployed in an operative mode with respect to a tanker truck;

FIG. 13 shows a plan view from above the embodiment shown in FIG. 12;

FIG. 14 shows an end elevation view of the embodiment shown in FIGS. 12 and 13;

FIG. 15 shows an isometric perspective view of a presently preferred embodiment of the present invention deployed in an operative mode with respect to a modular cargo tank;

FIG. 16 shows a plan view from above the embodiment shown in FIG. 15;

FIG. 17 shows an end elevation view of the embodiment shown in FIGS. 15 and 16 with the outboard section disposed in a retracted mode of operation;

FIG. 18 shows an isometric perspective view of a presently preferred embodiment of the present invention deployed in an operative mode with respect to a cargo tank of a rail car;

FIG. 19 shows a plan view from above the embodiment shown in FIG. 18;

FIG. 20 shows an end elevation view from one end of the embodiment shown in FIGS. 18 and 19 with the outboard section disposed in an extended mode of operation; and

FIG. 21 shows an end elevation view from one end of the embodiment shown in FIG. 18 with the platform deployed in the stored position above the cargo tank of the rail car and the outboard section disposed in an extended mode of operation and the floor extender deployed in the extended orientation.

Throughout the figures, the same reference numerals denote the same objects.

### DETAILED DESCRIPTION OF EXEMPLARY EMBODIMENTS OF THE PRESENT INVENTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action without necessarily requiring or implying any actual relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features unless otherwise specified herein. The terms “upstream” and “downstream” refer to the relative direction with respect to a flow or movement direction of a material and/or a fluid. For example, “upstream” refers to the direction from which a material and/or a fluid flows, and “downstream” refers to the direction to which the material and/or the fluid moves. The term “selectively” refers to a component's ability to operate in various states (e.g., an ON state and an OFF state) based on manual and/or automatic control of the component. The term “radial” defines a direction that is perpendicular to an axis of rotation and the term “axial” defines a direction that is parallel to the axis of rotation.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, powered together, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

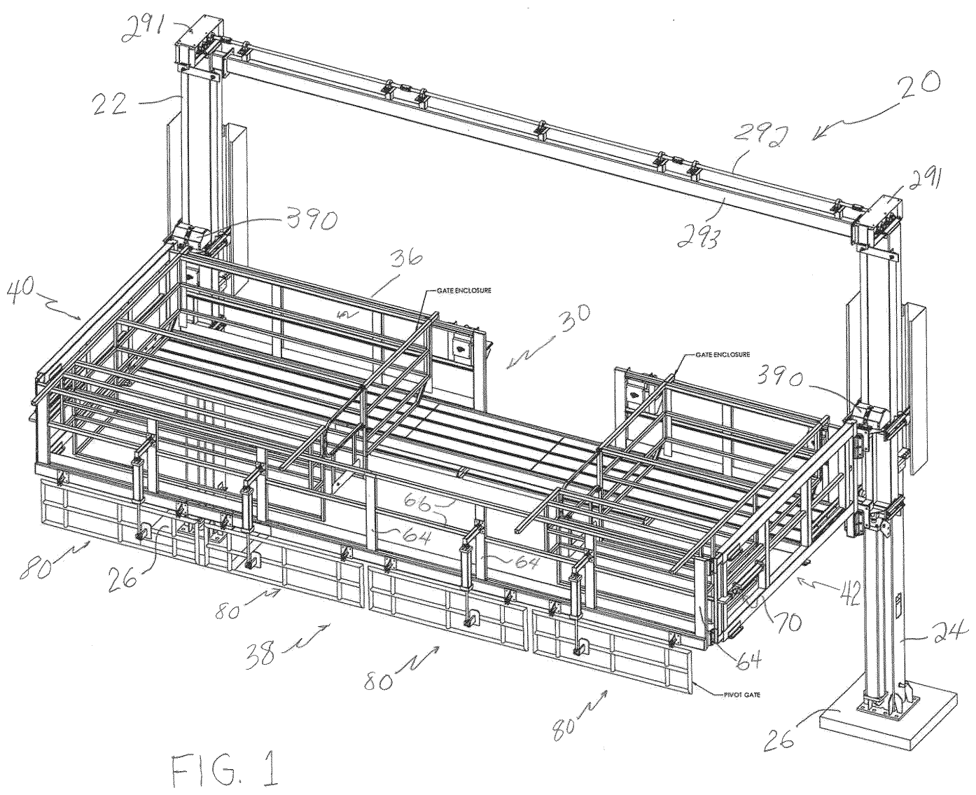

FIGS. 1 to 21 show different views of presently preferred embodiments of an elevating platform and certain components thereof in different configurations adapted to different containers for transporting bulk cargo. A presently preferred embodiment of the elevating platform is generally designated by the numeral 20. As schematically shown in FIGS. 1-3 for example, the elevating platform 20 includes a base frame that is generally designated by the numeral 30.

As schematically shown in FIGS. 1 and 3 for example, the base frame 30 is configured so that it can be raised and lowered while being oriented in a generally horizontal disposition with respect to the underlying ground. In this regard, the base frame 30 is cantilevered from a first support stanchion 22 and a second support stanchion 24. The first support stanchion 22 has a lower end resting on the underlying ground or on a concrete pad 26 that forms a foundation support lying on or embedded in the underlying ground. The lower end of the first support stanchion 22 desirably is anchored to the ground and extends vertically from the lower end to an upper end that is spaced apart from the lower end by a distance that suits the height needed to accommodate bulk cargo transport vehicles that are to be serviced by the elevating platform 20. As schematically shown in FIG. 1 for example, the second support stanchion 24 is disposed spaced apart from the first support stanchion 22 in a longitudinal direction, which is normal to the vertical direction. The second support stanchion 24 is configured and anchored like the first support stanchion 22. Each support stanchion desirably is made of steel and configured for carrying the weight of the base frame 30. Each of the stanchions 22, 24 desirably is configured as a hollow tubular member that elongates along a vertical axis. The cross-sectional shape of the hollow tubular member desirably is defined by a square in the direction taken transversely to the vertical axis, but other shapes such as circular or another polygonal shape also can be used.

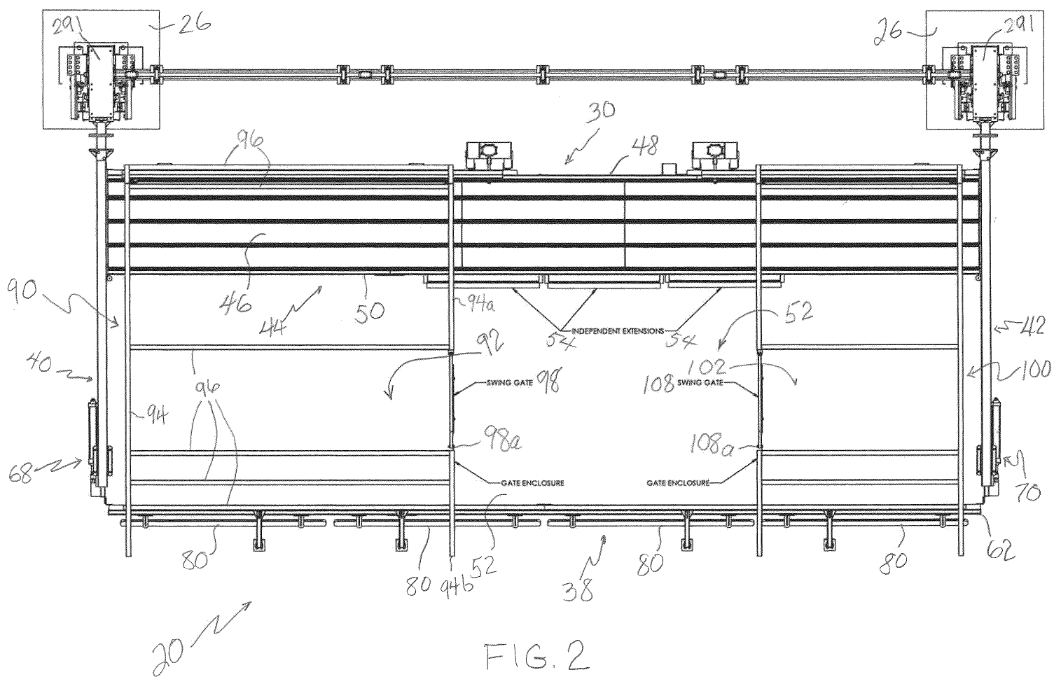

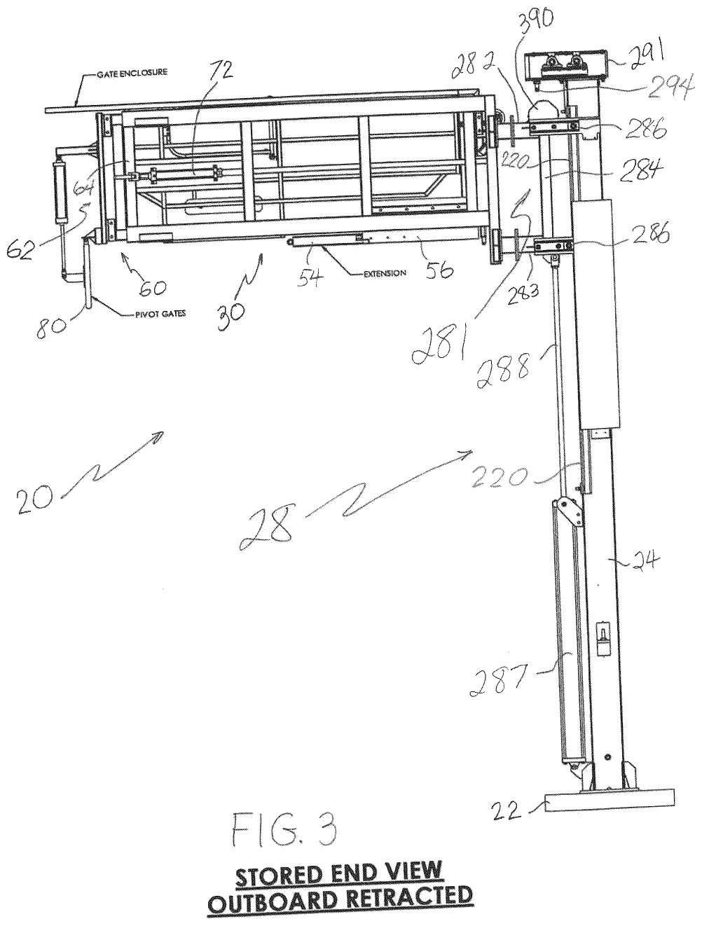

The base frame 30 generally defines the shape of a cuboid open at the top. In particular, as schematically shown in FIGS. 1 and 2 for example, the base frame 30 defines an inboard side 36 that is configured to form a wall or a fence-like structure elongating in the longitudinal direction that separates the first support stanchion 22 from the second support stanchion 24. The inboard side 36 of the base frame 30 also elongates in the vertical direction. The inboard side 36 of the base frame 30 is disposed to face toward and is adjacent the first support stanchion 22 and the second support stanchion 24.

As schematically shown in FIGS. 1 and 2 for example, the base frame 30 further defines an outboard side 38 that is spaced apart from the inboard side 36 in a direction away from the first support stanchion 22 and the second support stanchion 24. The outboard side 38 of the base frame 30 similarly is configured to form a wall or a fence-like structure that elongates in the longitudinal direction as well as the vertical direction.

As schematically shown in FIGS. 1 and 2 for example, the base frame 30 defines a front end 40 that is configured to form a wall or a fence-like structure elongating between the inboard side 36 and the outboard side 38 along a transverse direction that is normal to both the longitudinal direction and the vertical direction. The front end 40 of the base frame 30 also elongates in the vertical direction. The front end 40 of the base frame 30 is disposed near the first support stanchion 22.

As schematically shown in FIGS. 1 and 2 for example, the base frame 30 defines a back end 42 that is configured to form a wall or a fence-like structure elongating in the transverse direction between the inboard side 36 and the outboard side 38 of the base frame 30. The back end 42 of the base frame 30 also elongates in the vertical direction. The back end 42 of the base frame 30 is disposed near the second support stanchion 24. The back end 42 of the base frame 30 is spaced apart in the longitudinal direction from the front end 40 of the base frame 30. FIG. 6 provides a perspective view of a corner of the base frame 30 where the outboard side 38 and back end 42 come together.

As schematically shown in FIG. 3, the elevating platform 20 includes a lift mechanism, which is generally designated by the numeral 28 and is coupled to the first support stanchion 22 and to the second support stanchion 24. In this case, the load being carried by the lift mechanism 28 is the base frame 30, which is coupled to the lift mechanism 28, which desirably is configured to maintain a generally horizontal disposition of the base frame 30 during vertical travel of the base frame 30 with respect to the first support stanchion 22 and the second support stanchion 24.

As schematically shown in FIG. 3, the lift mechanism 28 desirably includes a carriage element that is generally designated by the numeral 281. Each of the first support stanchion 22 and the second support stanchion 24 is coupled to a carriage element 281 in a manner that effects a cantilevered disposition of the base frame 30 with respect to the first support stanchion 22 and the second support stanchion 24 while the lift mechanism 28 selectively raises and lowers the load composed of the base frame 30 in the vertical direction without changing the disposition of the base frame 30 with respect to the underlying ground.

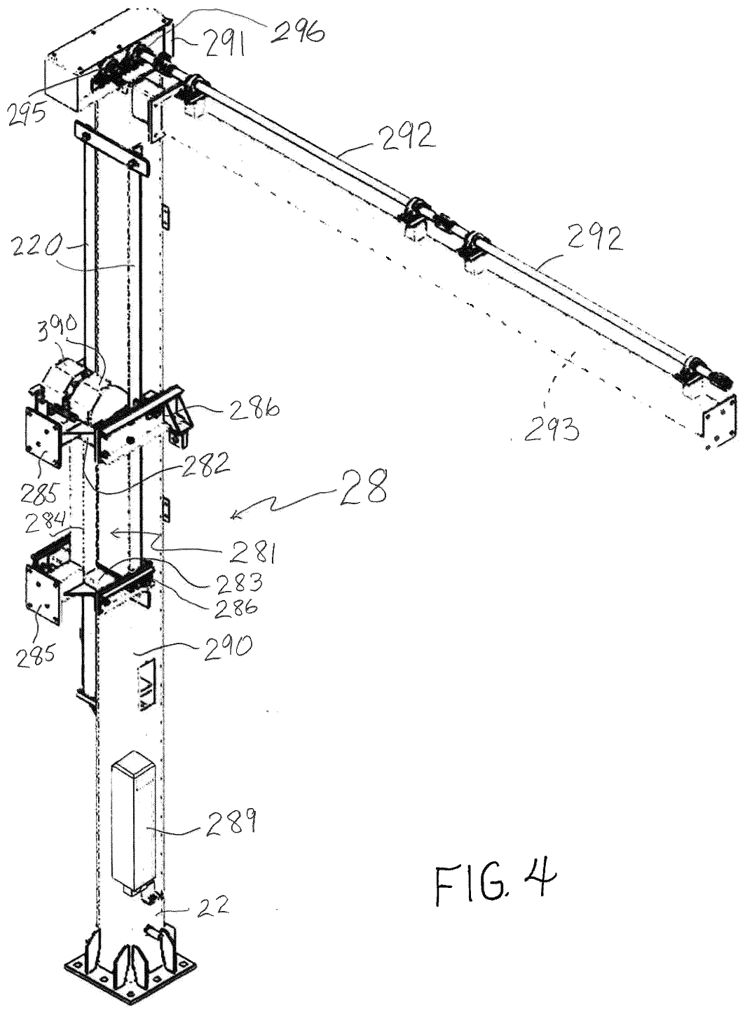

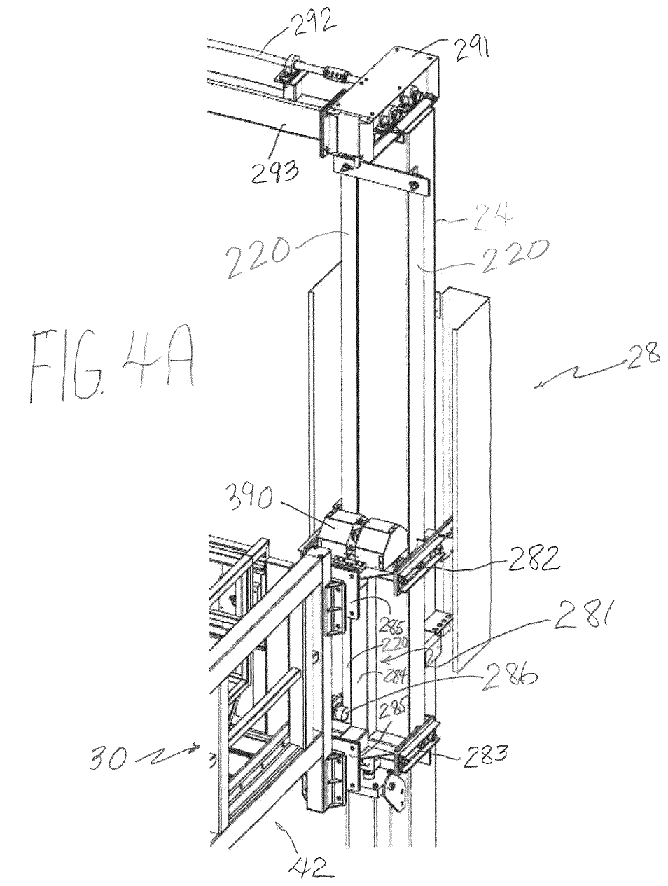

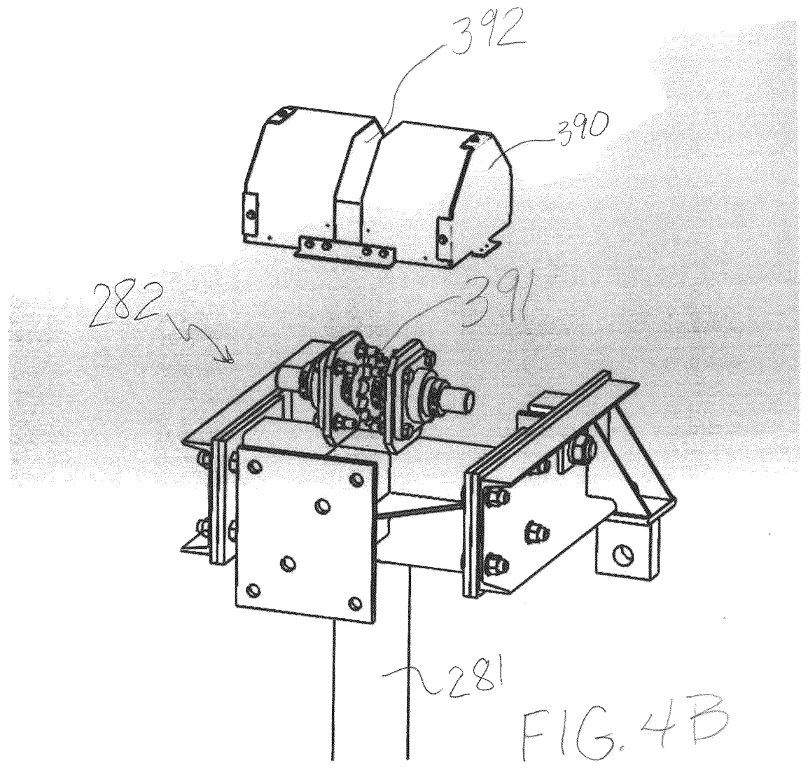

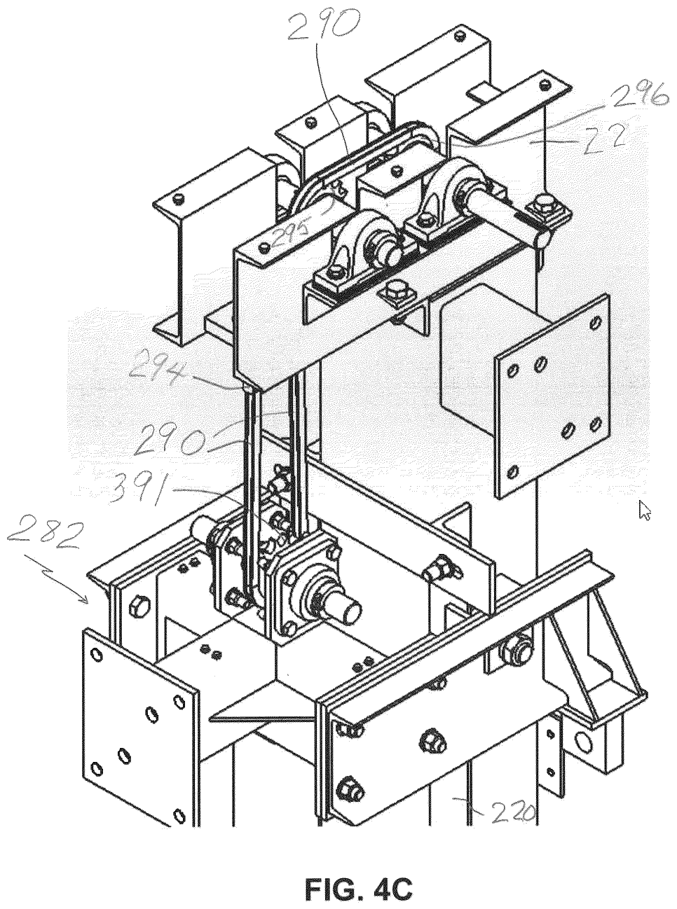

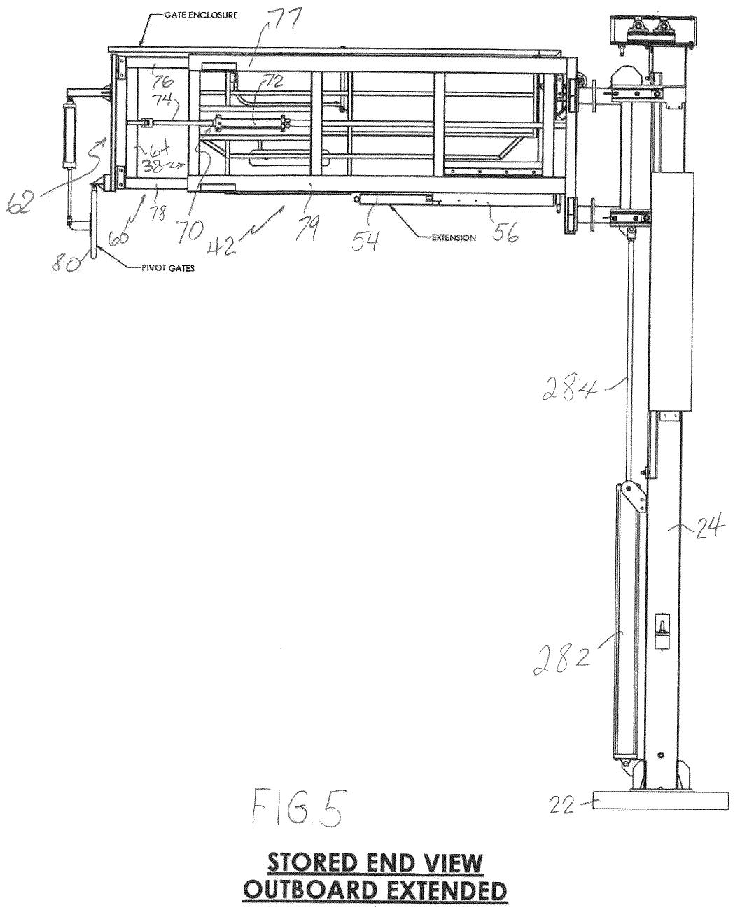

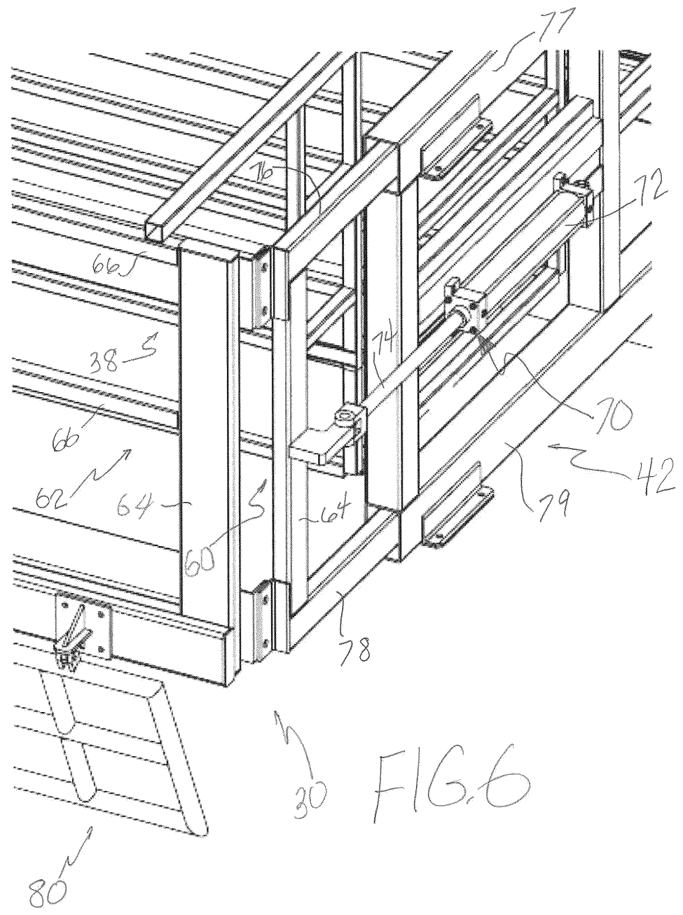

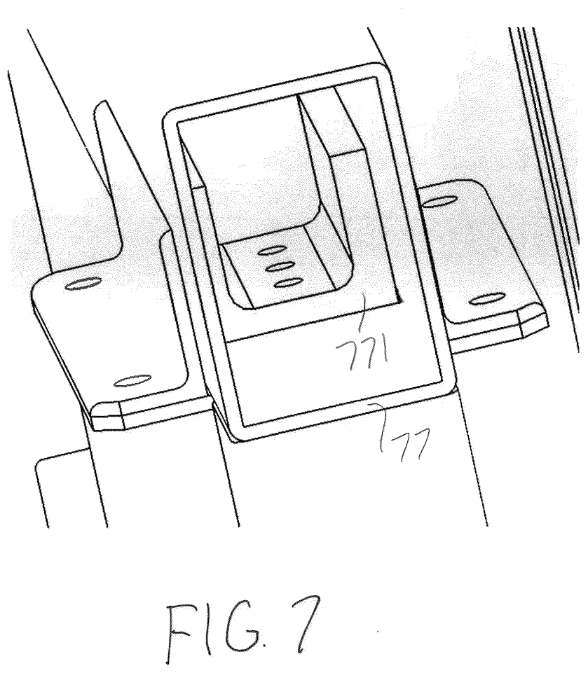

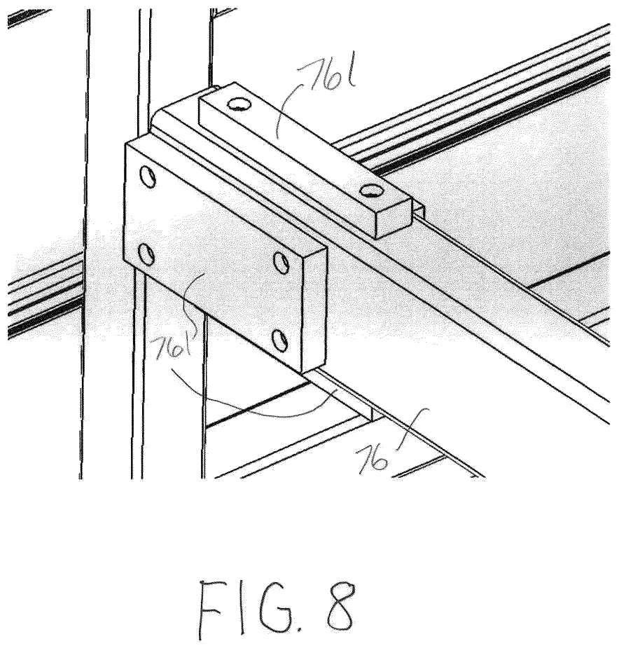

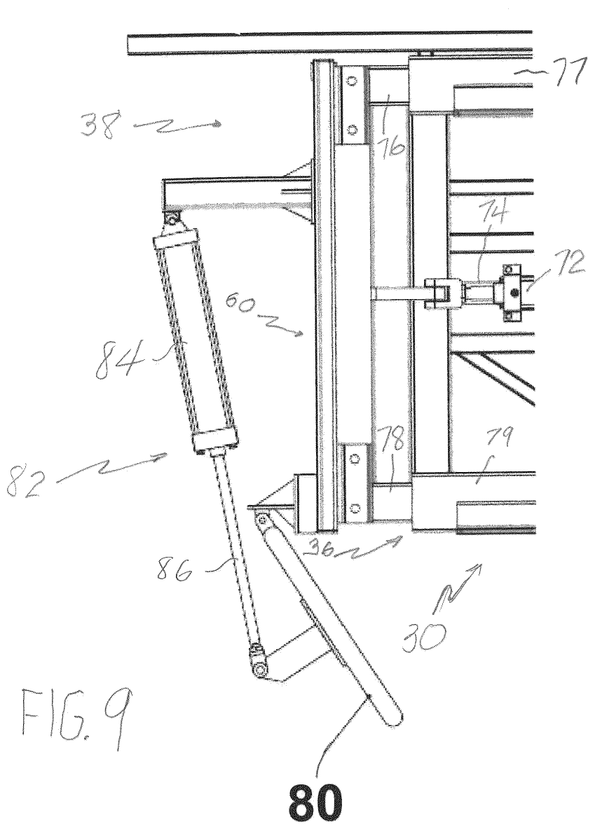

As shown in FIGS. 3 and 4A in connection with the second support stanchion 24 for example, each carriage element 281 includes an upper carriage support 282 and a lower carriage support 283. Each of the opposite ends of a carriage brace 284 is connected to one of the upper carriage support 282 and the lower carriage support 283 so as to keep them vertically spaced apart from each other.

As shown in FIGS. 4 and 4A, a distal end of each of the upper carriage support 282 and the lower carriage support 283 is connected to a support flange 285 that is configured to be attached to the base frame 30 shown in FIG. 3. Each of the oppositely disposed proximal ends of each of the upper carriage support 282 and the lower carriage support 283 is coupled to carriage load rollers 286 that are configured to roll against a vertically disposed guide track angle 220, which is defined along the exterior of each respective support stanchion 22, 24. The carriage load rollers 286 are configured to support the weight of the base frame 30 in a manner that permits the lifting mechanism 28 to raise and lower the base frame 30 cantilevered from the first and second support stanchions 22, 24. Thus, as schematically shown in FIGS. 3 and 4, the carriage load rollers 286 rotatably mounted to the upper carriage support 282 are disposed to roll against the inboard side of the guide track angle 220. While as schematically shown in FIG. 4A, the carriage load rollers 286 rotatably mounted to the lower carriage support 283 are disposed to roll against the outboard side of the guide track angle 220.

FIG. 4 depicts a schematic view of stanchion 22 that is shown partially disassembled in order to facilitate explanation of the functioning of the lifting mechanism 28 that includes the same elements associated with each of the support stanchions 22, 24. A respective counterweight 289 is disposed within the hollow space defined within each of the support stanchions 22, 24. The two counterweights 289 combine to offset the weight of the base frame 30 that is carried by the carriage elements 281 and lifted by the piston rod 288 and pressurized cylinder 287.

The counterweight system includes a chain and sprocket arrangement. As schematically shown in FIG. 4, a respective roller chain 290 is disposed within each of the support stanchions 22, 24. One end of each respective roller chain 290 is connected to the respective counterweight 289 within each of the respective support stanchions 22, 24. The opposite end of the roller chain 290 is anchored to a fixture 294, which is schematically shown in FIGS. 3 and 4C and disposed to depend from a plate located at the upper end of the respective stanchion 22, 24. As schematically shown in FIG. 4B for example, a carriage sprocket 391 is disposed underneath the cover plate 390 and rotatably carried by the upper carriage support 282. As schematically shown in FIG. 4C, from a respective fixture 294, the respective chain 290 engages a respective carriage sprocket 391 that is rotatably mounted to the upper carriage support 282. As schematically shown in FIG. 4B, the cover plate 390 is configured with a central opening 392 to permit ingress and egress of the chain 290 as the chain 290 winds around the lower half of the carriage sprocket 391 as schematically shown in FIG. 4C.

As schematically shown in FIG. 4C, the chain 290 travels from the carriage sprocket 391 to the outboard stanchion sprocket 295, which is carried atop the upper carriage support 282 and rotatably aligned to receive the chain 290 from the carriage sprocket 391. An inboard stanchion sprocket 296 is carried atop the upper carriage support 282 and rotatably aligned with the outboard stanchion sprocket 295. As schematically shown in FIG. 4, the inboard stanchion sprocket 296 is also rotatably aligned with the respective counterweight 289. As schematically shown in FIG. 4C, the chain 290 travels from the outboard stanchion sprocket 295 to the inboard stanchion sprocket 296 and traverses across the upper portions of both the outboard stanchion sprocket 295 and the inboard stanchion sprocket 296. By transversely separating the oppositely draped sections of the chain 290, these side-by-side stanchion sprockets 295, 296 function as would a single stanchion sprocket of much larger diameter than the two side-by-side stanchion sprockets 295, 296.

As schematically shown in FIG. 4, the chain 290 travels from the inboard stanchion sprocket 296 to the respective counterweight 289. Each respective roller chain 290 is long enough to reach beyond the top of each of the support stanchions 22, 24 and engage the two stanchion sprockets 295, 296 disposed beneath a respective sprocket cap assembly 291 that is disposed at the uppermost end of each of the respective support stanchions 22, 24. The respective counterweight 289, roller chain 290, carriage sprocket 391 and stanchion sprockets 295, 296 carried beneath the upper sprocket cap assembly 291 cooperate to reduce the work that needs to be done by the piston rod 288 and pressurized cylinder 287 in raising and lowering the base frame 30.

As schematically shown in FIG. 4, a pair of coupling rods 292 is rotatably supported on a cross bar 293, which is defined in a dashed line. As schematically shown in FIG. 4A, one respective opposite end of the combined coupling rods 292 is connected to the respective inboard stanchion sprocket 296 of the respective sprocket cap assembly 291 of each of the respective support stanchions 22, 24. The coupling rods 292 ensure that the movements of the respective counterweights 289 within the respective stanchions 22, 24 move at the same rate and remain synchronized. The cross bar 293 is configured and disposed to extend between the respective support stanchions 22, 24 and functions to relieve any longitudinal stress and tension from the coupling rods 292. In this way, the combined coupling rods 292 ensure simultaneous and commensurate movement of the respective counterweights 289 (FIG. 4) and accordingly ensure that each opposite end of the base frame 30 remains at the same height above the underlying ground during raising and lowering movement of the base frame 30 by the lifting mechanism 28.

As shown in FIG. 3 in connection with the second support stanchion 24 for example, a presently preferred embodiment of the lift mechanism 28 desirably includes a pressurized cylinder 287 having one end pivotally coupled to the lower end of the second support stanchion 24. The pressurized cylinder 287 desirably is configured with a piston (not shown) slidably contained within the interior of the pressurized cylinder 287, which also contains a pressurized fluid such as a compressible fluid like air or an incompressible fluid such as hydraulic fluid. The piston is configured and disposed in the interior of the pressurized cylinder 287 to divide the interior into two separate chambers. A piston rod 288 has an internal end (not shown) connected to the piston and an opposite external end that is pivotally coupled to a lower portion of the lower carriage support 283. Activation of the lift mechanism 28 causes the pressurized fluid (typically air) within the pressurized cylinder 287 to force the piston upward and move the piston rod 288 out of the upper end of the pressurized cylinder 287. In the reverse operation of the lift mechanism 28, deactivation of the lift mechanism 28 causes the pressurized fluid within the pressurized cylinder 287 to abate and allow the piston to retreat downward and move the piston rod 288 into the upper end of the pressurized cylinder 287. The first support stanchion 22 likewise is provided with a respective pressurized cylinder 287 and piston rod 288.

As schematically shown in FIG. 2 for example, the elevating platform 20 includes a floor 44 that is carried by the base frame 30. The floor 44 is configured and disposed to define a walking surface 46 that supports multiple workers standing on and walking across the floor 44 as well as carrying bulk cargo and/or equipment for loading and offloading bulk cargo. The floor 44 is configured to elongate from the front end 40 of the base frame 30 to the back end 42 of the base frame 30. The floor 44 defines an inboard edge 48 disposed adjacent the inboard side 36 of the base frame 30. The floor 44 defines an outboard edge 48 disposed away from the inboard edge 48 in the transverse direction. The outboard edge 50 of the floor 44 is disposed spaced away from the outboard side 50 of the base frame 30. Thus, between them, the outboard edge 50 of the floor 44 and the outboard side 38 of the base frame 30 define longitudinally extending borders of an access opening 52 through the floor 44. This access opening 52 desirably can be variously configured in a manner that allows the workers supported on the floor 44, direct access to the top of the containers transporting the bulk cargo that is to be loaded or offloaded. Moreover, the access opening 52 desirably further is able to be configured to help guard against workers falling through any gaps between the top of the containers and the edge defining the access opening 52.

As schematically shown in FIG. 2 for example, the elevating platform 20 includes at least one floor extension 54. Desirably, a plurality of floor extensions 54 is provided. In the embodiment shown, there are three separate floor extensions 54. However, in accordance with the disclosure presented herein, it is possible to provide a number of floor extensions 54 greater than three or fewer than three. Each of the plurality of floor extensions 54 is configured to be slidably carried beneath the floor 44. Each of the plurality of floor extensions 54 is configured for being selectively extendable to at least partially close the access opening 52 and selectively retractable to widen the access opening 52. Thus, by different degrees of extension and contraction of each of the plurality of floor extensions 54, both the size and shape of the access opening 52 can be customized to suit the particular configuration of the top of the bulk cargo transport vehicles that are to be serviced by the elevating platform 20.

As schematically shown in FIGS. 3 and 5 for example, the elevating platform 20 includes a plurality of floor actuators 56. A respective one of each of the plurality of floor actuators 56 is coupled to a respective one of each of the plurality of floor extensions 54. In this way, each of the floor actuators 56 is configured for moving a respective one of the plurality of floor extensions 54 between a retracted position disposed beneath the floor 44 and an extended position that at least partially closes the access opening 52. Each of the plurality of floor actuators 56 is carried by the floor 44. The retracted position of the floor extension 54 and floor actuator 56 is schematically shown in FIG. 3. The extended position of the floor extension 54 and floor actuator 56 is schematically shown in FIG. 5.

As schematically shown in FIGS. 3, 5 and 6 for example, the elevating platform 20 includes a lateral extender that is generally designated by the numeral 60. As schematically shown in FIGS. 1-3, 5 and 6 for example, the lateral extender 60 defines an outboard fence 62 that extends longitudinally and parallel to the outboard side 38 of the base frame 30. As schematically shown in FIG. 1, the outboard fence 62 includes a plurality of vertically extending fence posts 64 that are connected to and carry longitudinally extending fence railings 66. As schematically shown in FIGS. 5 and 6 for example, the lateral extender 60 is coupled to the back end 42 of the base frame 30. Though not visible in the views shown in FIGS. 5 and 6, the lateral extender 60 is likewise coupled to the front end 40 of the base frame 30.

The lateral extender 60 is configured for slidable movement with respect to both the front end 40 of the base frame 30 and the back end 42 of the base frame 30 in a transverse direction that is toward and away from the outboard side 38 of the base frame 30 shown in FIGS. 1 and 2 for example. Thus, the lateral extender 60 is in this sense considered to be coupled between the outboard side 38 of the base frame 30 and each of the front end 40 of the base frame 30 and the back end 42 of the base frame 30. FIG. 3 schematically shows the lateral extender 60 disposed in a fully retracted orientation resting against the outboard side 38 of the base frame 30. This is the so-called inboard position of the lateral extender 60. Each of FIGS. 5 and 6 schematically shows the lateral extender 60 disposed in a fully extended orientation and resting spaced apart in the transverse direction from the outboard side 38 of the base frame 30. This is the so-called outboard position of the lateral extender 60.

The elevating platform 20 includes a lateral actuator mechanism that is carried by the base frame 30 and connected to the lateral extender 60. The lateral actuator mechanism is configured for selectively moving the lateral extender 60 between an outboard position as in FIGS. 5 and 6 and an inboard position as in FIG. 3. The lateral actuator mechanism disposes the lateral extender 60 away from each of the outboard side 38 of the base frame 30 at both the front end 40 of the base frame 30 and the back end 42 of the base frame 30.

Moreover, as schematically shown in FIG. 2 for example, the lateral actuator mechanism desirably includes a front lateral actuator, which is generally designated by the numeral 68, and a back lateral actuator, which is generally designated by the numeral 70. The front lateral actuator 68 desirably is carried by the front end 40 of the base frame 30. Similarly, the back lateral actuator 70 is carried by the back end 42 of the base frame 30 as schematically shown in FIGS. 4, 4A, 5 and 6. The front lateral actuator 68 and the back lateral actuator 70 desirably are configured to operate in tandem so as to move a front end of the lateral extender 60 at the same rate of translation as a back end of the lateral extender 60. By moving both opposite ends of the lateral extender 60 with the same rate of translation, the lateral extender 60 retains a disposition parallel to the outboard side 38 of the base frame 30 as the lateral extender 60 is being moved away from the outboard side 38 of the base frame 30 to the outboard position of the lateral extender 60 schematically shown in FIGS. 5 and 6 or being moved toward the outboard side 38 of the base frame 30 to the inboard position of the lateral extender 60 schematically shown in FIG. 3.

As schematically shown in FIGS. 5 and 6, the back lateral actuator 70 desirably includes a pressurized cylinder 72 having one end coupled to the back end 42 of the base frame 30. The back lateral actuator 70 desirably includes a piston rod 74 having one opposite end connected to a piston that is slidably received within the pressurized cylinder 72. The opposite end of the piston rod 74 is connected to the lateral extender 60 and configured to slide into and out of the pressurized cylinder 72.

As schematically shown in FIGS. 5 and 6, the lateral extender 60 includes an upper slide bar 76 and a lower slide bar 78. The upper slide bar 76 has one end connected to a fence post 64 that is disposed on a back end of the outboard fence 62. As schematically shown in FIG. 6, the opposite end of the upper slide bar 76 is configured to telescope into and out of a hollow upper extrusion 77 that forms part of the back end 42 of the base frame 30. The lower slide bar 78 has one end connected to the fence post 64 that is disposed on a back end of the outboard fence 62. The opposite end of the lower slide bar 78 is configured to telescope into and out of a hollow lower extrusion 79 that forms part of the back end 42 of the base frame 30.

The end of the piston rod 74 connected to the lateral extender 60 is connected to the same fence post 64 that is connected to the upper slide bar 76 and the lower slide bar 78. Activation of the back lateral actuator 70 selectively moves the piston and attached piston rod 74 into and out of the pressurized cylinder 72 and commensurately moves the back end of the lateral extender 60 between the inboard position and the outboard position of the lateral extender 60. The front lateral actuator 68 schematically shown in FIG. 1 is configured and operates in the same fashion as the back lateral actuator 70 schematically shown in FIGS. 1, 5 and 6 for example. Thus, the front lateral actuator 68 and the back lateral actuator 70 desirably are configured to operate in tandem so as to move the front end of the lateral extender 60 at the same rate of translation as the back end of the lateral extender 60.

The telescoping movement between each of the upper slide bar 76 and the lower slide bar 78 on the one hand and the respective hollow upper extrusion 77 and hollow lower extrusion 79 on the other hand, desirably is facilitated by ultra high molecular weight components that interface with each other during the respective telescoping movements. As schematically shown in FIG. 7 for example, a cradle member 771 is disposed within and fixed within the distal end of the hollow upper extrusion 77. The cradle member 771 desirably is shaped as a C-channel and formed of ultra high molecular weight material such as polypropylene. A similar cradle member 771 is likewise disposed within the lower hollow extrusion 76. As schematically shown in FIG. 8 for example, the distal end of the upper slide bar 76 is provided with veneer strips 761 that surround all sides of the distal end of the upper slide bar 76. The veneer strips 761 are formed of ultra high molecular weight material such as polypropylene. Due to the relatively favorable coefficients of friction of polypropylene, during telescoping movements, the veneer strips 761 freely slide against and within the C-channel formed by the cradle member 771 similarly composed of polypropylene.

As schematically shown in FIGS. 1-3, 5, 6 and 9 for example, the elevating platform 20 includes a pivoting fence that is generally designated by the numeral 80. In the embodiment shown in FIG. 1 for example, four separate pivoting fences 80 are aligned end-to-end in the longitudinal direction. One pivoting fence 80 is disposed closest to the front end 40 of the base frame 30 and designated the front pivoting fence 80. One pivoting fence 80 is disposed closest to the back end 42 of the base frame 30 and designated the back pivoting fence 80. A third and fourth pivoting fence 80 are disposed between the other two and generally in the middle section of the base frame 30 and respectively designated a forward middle pivoting fence 80 and a backward middle pivoting fence 80.

Each of the pivoting fences 80 is coupled to the outboard side 38 of the base frame 30. Desirably, each pivoting fence 80 is coupled by the lateral extender 60 to the outboard side 38 of the base frame 30. Desirably, each pivoting fence 80 is carried by the lateral extender 60 and pivotally connected to the lateral extender 60. Thus, each pivoting fence 80 can be said to be pivotally coupled to the outboard side 38 of the base frame 30 and to depend from the outboard side 38 of the base frame 30 in a direction that extends beneath the floor 44. As schematically shown in FIGS. 1 and 2, each pivoting fence 80 elongates in the longitudinal direction between the back end 42 of the base frame 30 and the front end 40 of the base frame 30.

The elevating platform includes a pivoting fence actuator carried by the outboard side 38 of the base frame 30. As schematically shown in FIG. 9, each respective pivoting fence actuator is generally designated by the numeral 82. Each pivoting fence actuator 82 desirably has one end pivotally connected to the lateral extender 60 and one end pivotally connected to each respective pivoting fence 80. Each pivoting fence actuator 82 is configured for selectively moving the respective pivoting fence 80 between a depending position and an inboard-pointing position. In the depending position, the pivoting fence 80 is disposed generally vertically from the outboard side 38 of the base frame 30 as schematically shown in FIGS. 3, 5 and 6. In an inboard-pointing position schematically shown in FIG. 9, the respective pivoting fence 80 is disposed to pivot toward the inboard side 36 of the base frame 30.

As schematically shown in FIG. 9, each respective pivoting fence actuator 82 desirably includes a pressurized cylinder 84 having one end coupled to the outboard side 38 of the base frame 30 via a stand-off member 85, which has one end pivotally connected to one end of the pressurized cylinder 84. The opposite end of the stand-off member 85 is connected to the lateral extender 60. In this manner, the pivoting fence actuator 82 becomes disposed spaced apart from the outboard side 38 of the base frame 30. The pivoting fence actuator 82 includes a piston slidably received within the pressurized cylinder 84 and coupled to a rod 86 having one end pivotally connected to the pivoting fence 80. As schematically shown in FIG. 9, because each pivoting fence 80 is pivotally coupled to the lateral extender 60 and the rod 86 is pivotally coupled to the pivoting fence 80, extension of the rod 86 away from the cylinder 84 moves the pivoting fence 80 to the inboard position of the pivoting fence 80. Likewise, retraction of the rod 86 into the cylinder 84 moves the pivoting fence 80 to the depending position of the pivoting fence 80 shown in FIGS. 3 and 4.

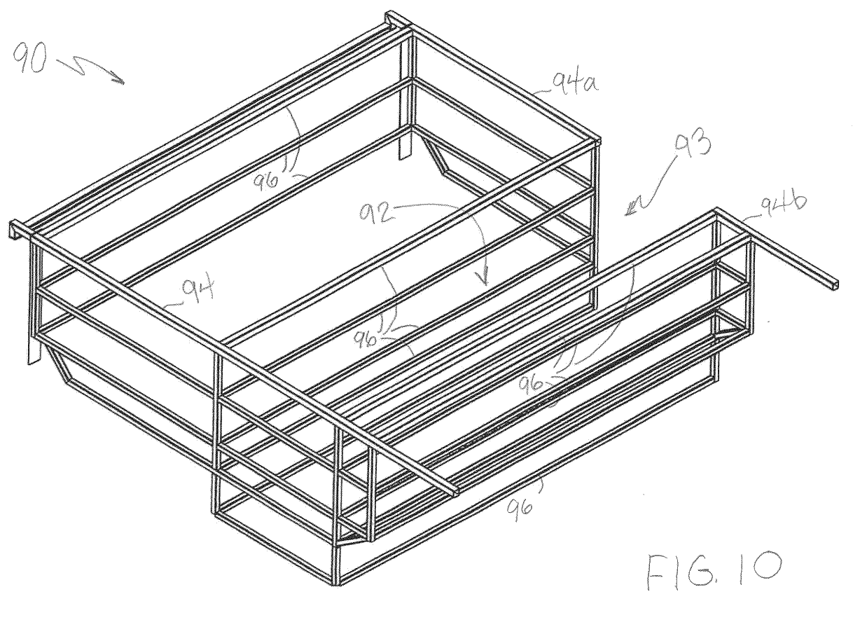

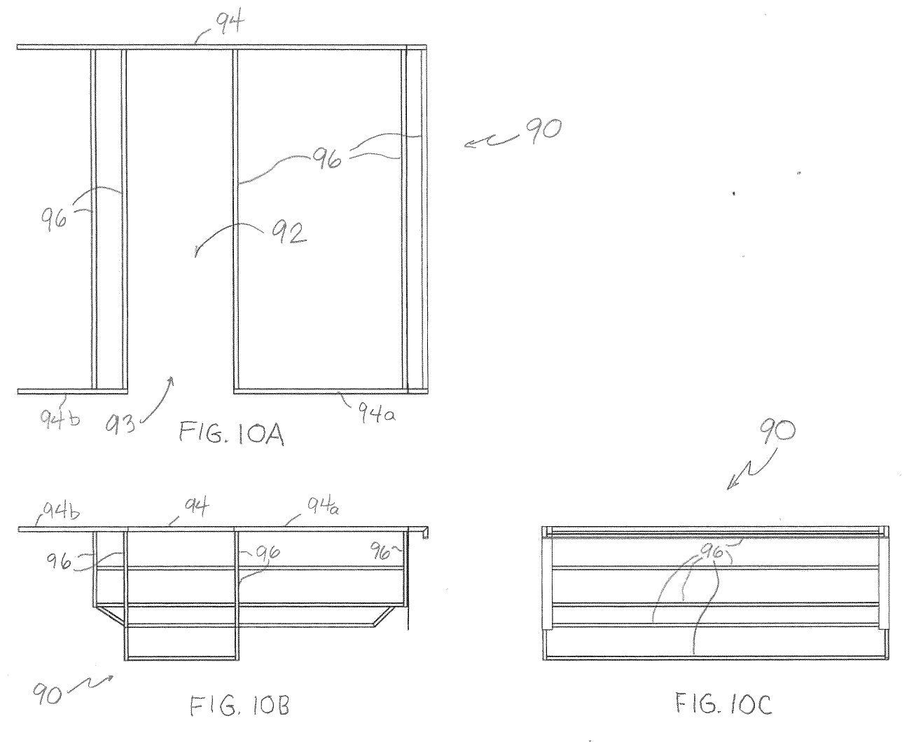

As schematically shown in FIG. 2 for example, the elevating platform 20 includes a front cage that is generally designated by the numeral 90. To facilitate the following explanation, FIG. 10 depicts a perspective view of the embodiment of the front cage 90 shown in FIG. 2, and each of FIGS. 10A, 10B, and 10C respectively depicts a top plan view, a side plan view and a rear plan view of the front cage 90. As schematically shown in FIG. 10, the front cage 90 defines an interior 92 thereof. As schematically shown in FIG. 2, the interior 92 of the front cage 90 is spaced apart in the transverse direction from both the inboard side 36 and the outboard side 38 of the base frame. As schematically shown in FIG. 10, the front cage 90 includes a pair of longitudinally spaced apart end rails 94 that extend in a transverse direction.

One of the end rails 94 elongates continuously in the transverse direction and is disposed near the front end 40 of the base frame 30, but spaced longitudinally apart from the front end 40 of the base frame 30. As schematically shown in FIG. 10, the other end rail 94 elongates transversely in two separated sections, an inboard section 94a and an outboard section 94b of the end rail 94. The inboard and outboard sections 94a, 94b are interrupted to define a front cage opening 93 to the interior 92 of the front cage 90.

The front cage 90 desirably includes a plurality of longitudinally extending rails 96 that extend in the longitudinal direction between the end rails 94. Each of the opposite ends of each of the longitudinally extending rails 96 is connected to one of the end rails 94. The end rails 94 in turn are carried by the base frame 30 and connected to the base frame 30, and thus the front cage 90 is carried by the base frame 30 and connected to the base frame 30.

The rearwardly disposed end rail 94 of the front cage 90 is spaced farther in the longitudinal direction from the front end 40 of the base frame 30 and is configured to transform the front cage into a gated barrier. This rearwardly disposed end rail 94 of the front cage 90 is disposed adjacent the access opening 52 that is partially defined by the outboard edge 50 of the floor 44 of the base frame 30. The two separate sections 94a, 94b of this rearwardly disposed and discontinuous end rail 94 of the front cage 90 define a gap that partially defines the front cage opening 93 between the interior 92 of the front cage 90 and the access opening 52 of the base frame 30. As shown in FIG. 2, the front cage opening 93 is partially defined by a vertically disposed inboard door jamb 93a, which depends vertically from the inboard section 94a of the end rail 94, and an outboard door jamb 93b, which is similarly vertically disposed and depends from the outboard section 94b of the end rail 94.

A front swing gate 98 spans across the front cage opening 93 in the rearwardly disposed end rail 94 of the front cage 90 to complete the gated barrier. One edge of the front swing gate 98 is pivotally connected to the inboard door jamb 93a of the front cage 90 in a manner that only permits the front swing gate 98 to pivot toward the interior 92 of the front cage 90. The opposite edge of the front swing gate 98 includes a latching mechanism 98a that is configured to securely connect the front swing gate 98 to the outboard door jamb 93b of the front cage 90. The latching mechanism 98a is configured to be selectively activated and de-activated to respectively connect and disconnect the front swing gate 98 to the outboard door jamb 93b of the discontinuous end rail 94 of the front cage 90. The latching mechanism 98a desirably is manually operated. In this way, the front swing gate 98 is configured and disposed to control worker access between the interior 92 of the front cage 90 and the access opening 52 through the floor 44 of the elevating platform 20 and thus perform a function of a gated barrier.

In an alternative embodiment, the front swing gate 98 can include an actuator that is selectably controllable to lock the front swing gate 98 in a closed orientation that prevents worker access between the interior 92 of the front cage 90 and the access opening 52 through the floor 44 of the elevating platform 20. The actuator of the latching mechanism 98a in the alternative embodiment desirably is operated remotely from the front swing gate 98 at a control panel (not shown) that is remotely disposed from the front cage 90.

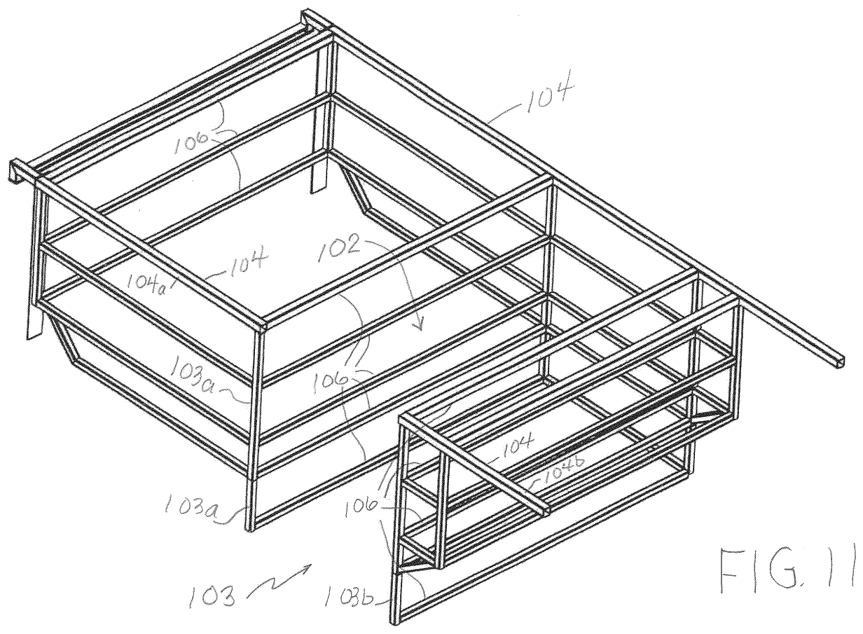

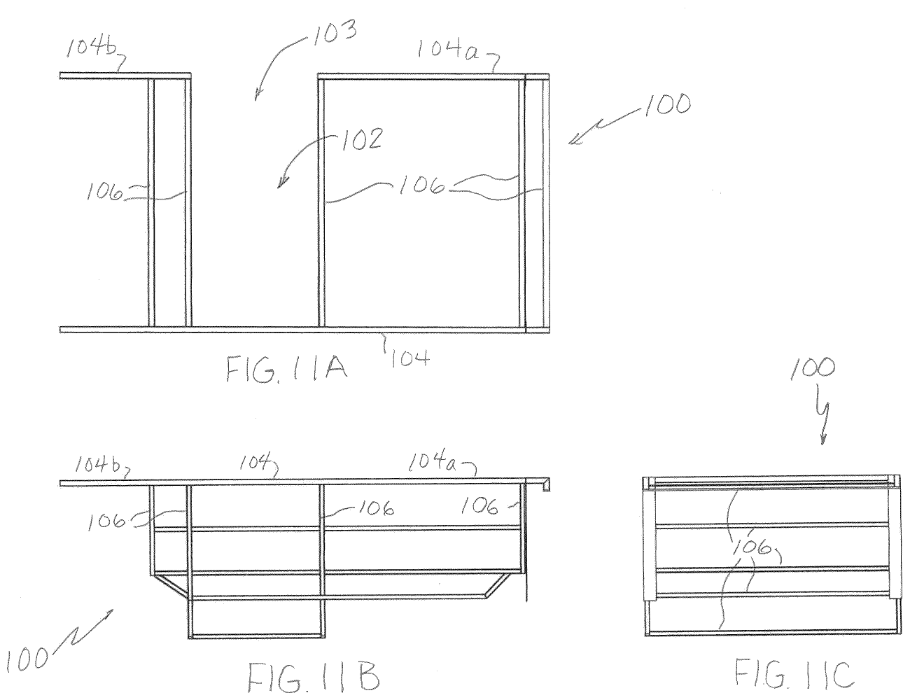

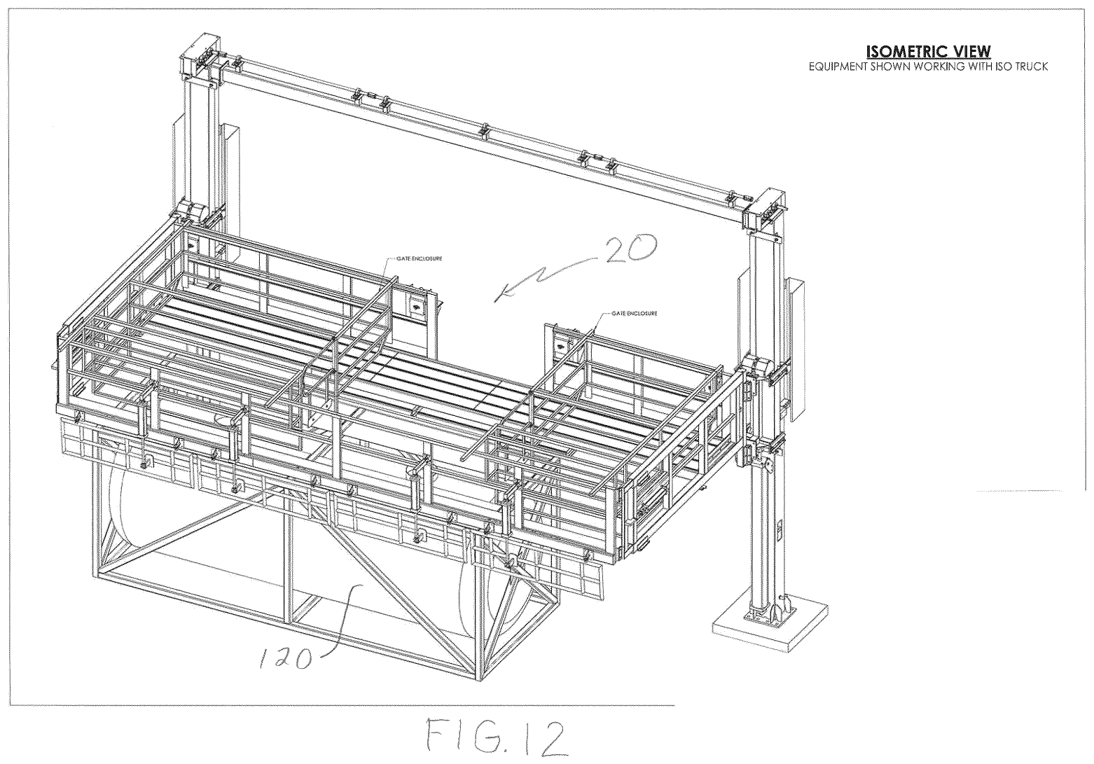

As schematically shown in FIG. 2 for example, the elevating platform 20 includes a back cage that is generally designated by the numeral 100. To facilitate the following explanation, FIG. 11 depicts a perspective view of the embodiment of the back cage 100 shown in FIG. 2, and each of FIGS. 11A, 11B, and 11C respectively depicts a top plan view, a side plan view and a rear plan view of the back cage 100. As schematically shown in FIG. 11, the back cage 100 defines an interior 102 thereof. As schematically shown in FIG. 2, the interior 102 of the back cage 100 is spaced apart in the transverse direction from both the inboard side 36 and the outboard side 38 of the base frame 30. As schematically shown in FIG. 11, the back cage 100 includes a pair of longitudinally spaced apart end rails 104 that extend in a transverse direction.

One of the end rails 104 elongates continuously in the transverse direction and is disposed near the back end 42 of the base frame 30, but spaced longitudinally apart from the back end 42 of the base frame 30. As schematically shown in FIG. 11, the other end rail 104 elongates transversely in two separated sections, an inboard section 104a and an outboard section 104b of the end rail 104. The inboard and outboard sections 104a, 104b are interrupted to define a back cage opening 103 to the interior 102 of the back cage 100.

The back cage 100 desirably includes a plurality of longitudinally extending rails 106 that extend in the longitudinal direction between the end rails 104. Each of the opposite ends of each of the longitudinally extending rails 106 is connected to one of the end rails 104. The end rails 104 in turn are carried by the base frame 30 and connected to the base frame 30, and thus the back cage 100 is carried by the base frame 30 and connected to the base frame 30.

The forwardly disposed end rail 104 of the back cage 100 is spaced farther in the longitudinal direction from the back end 42 of the base frame 30 and is configured to transform the front cage into a gated barrier. This forwardly disposed end rail 104 of the back cage 100 is disposed adjacent the access opening 52 that is partially defined by the outboard edge 50 of the floor 44 of the base frame 30. The two separate sections 104a, 104b of this forwardly disposed and discontinuous end rail 104 of the back cage 100 define a gap that partially defines the back cage opening 103 between the interior 102 of the back cage 100 and the access opening 52 of the base frame 30. As shown in FIG. 2, the back cage opening 103 is partially defined by a vertically disposed inboard door jamb 103a, which depends vertically from the inboard section 104a of the end rail 104, and an outboard door jamb 103b, which is similarly vertically disposed and depends from the outboard section 104b of the end rail 104.

A back swing gate 108 spans across the back cage opening 103 in the rearwardly disposed end rail 104 of the back cage 100 to complete the gated barrier. One edge of the back swing gate 108 is pivotally connected to the inboard door jamb 103a of the back cage 100 in a manner that only permits the back swing gate 108 to pivot toward the interior 102 of the back cage 100. The opposite edge of the back swing gate 108 includes a latching mechanism 108a that is configured to securely connect the back swing gate 108 to the outboard door jamb 103b of the back cage 100. The latching mechanism 108a is thus configured to be selectively activated and de-activated to respectively connect and disconnect the back swing gate 108 to the outboard door jamb 103b of the discontinuous end rail 104 of the back cage 100. In this way, the back swing gate 108 is configured and disposed to control worker access between the interior 102 of the back cage 100 and the access opening 52 through the floor 44 of the elevating platform 20 and thus perform a function of the gated barrier.

In an alternative embodiment, the back swing gate 108 can include an actuator that is selectably controllable to lock the back swing gate 108 in a closed orientation that prevents worker access between the interior 102 of the back cage 100 and the access opening 52 through the floor 44 of the elevating platform 20. The actuator of the latching mechanism 108a in the alternative embodiment desirably is operated remotely from the back swing gate 108 at a control panel (not shown) that is remotely disposed from the back cage 100.

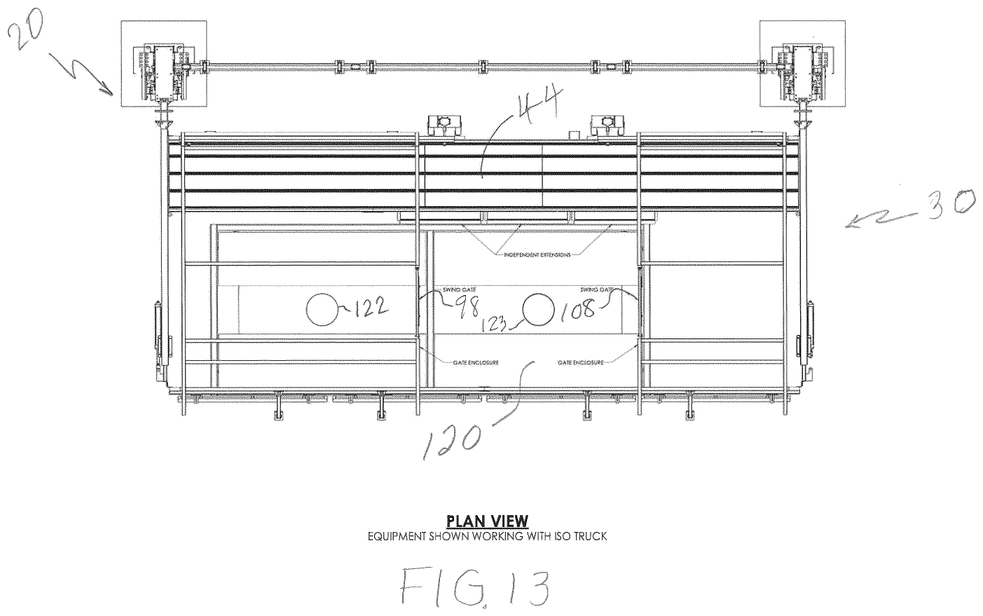

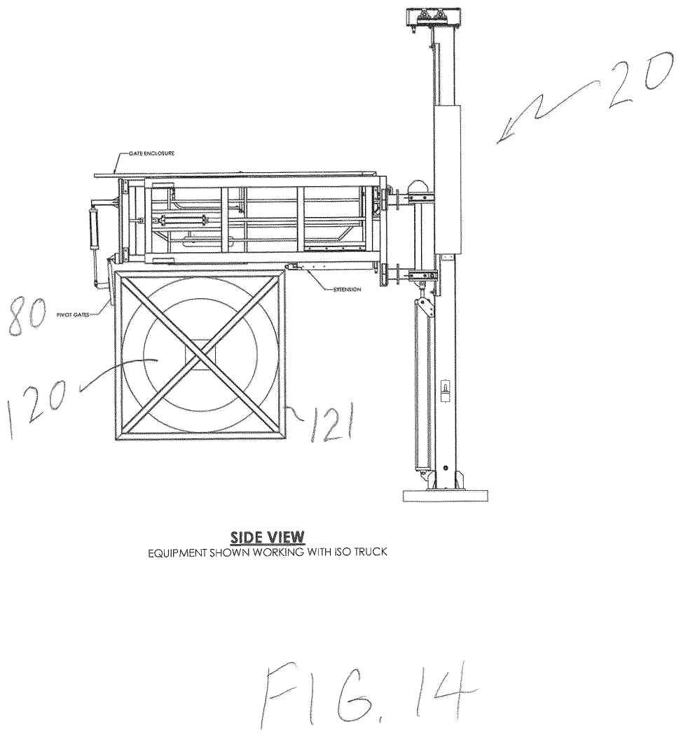

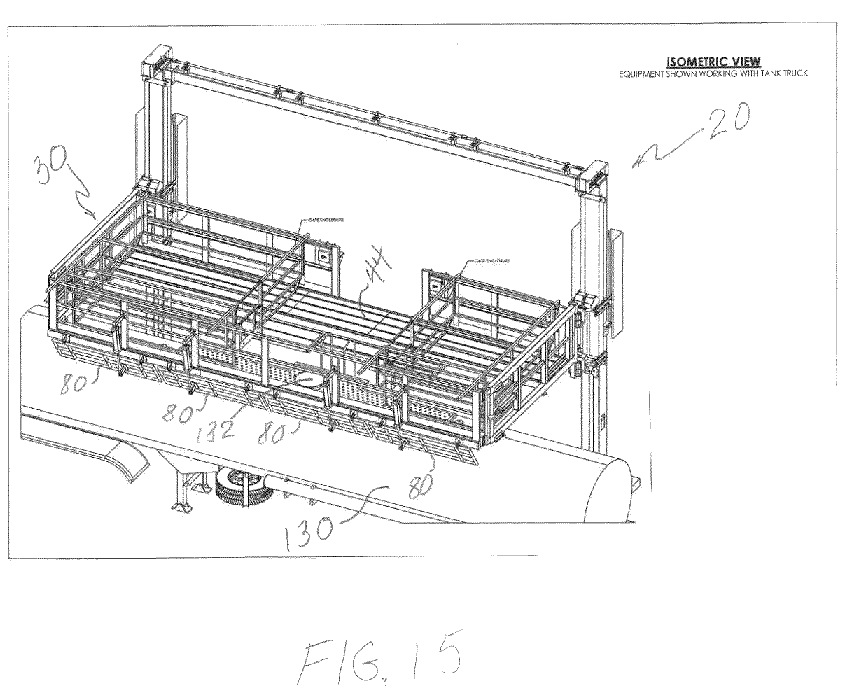

FIGS. 12-14 show different views of an embodiment of the elevating platform 20 in relation to a tank container 120 that would be carried on a flat bed truck (not shown) for example. FIG. 12 is an elevated isometric view. FIG. 13 is a plan view from above the elevating platform 20. FIG. 14 is an elevation view from a back end of the tank container 120 As shown in FIG. 13, the tank container 120 includes a front loading hatch 122 and a rear loading hatch 123. Each of the front swing gate 98 and the back swing gate 108 is deployed in the closed and locked orientation so as to isolate the front loading hatch 122 from the rear loading hatch 123 and accordingly limit access to just the rear loading hatch 123 for workers walking on the floor 44. As shown in FIG. 14, a pivoting fence 80 is deployed to rest against the shipping frame 121 that surrounds and supports the tank container 120.

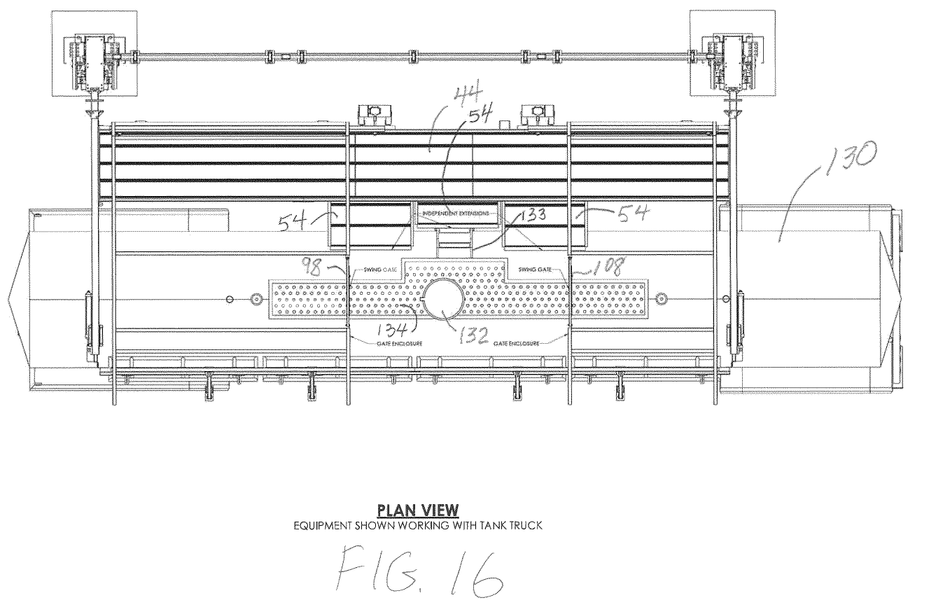

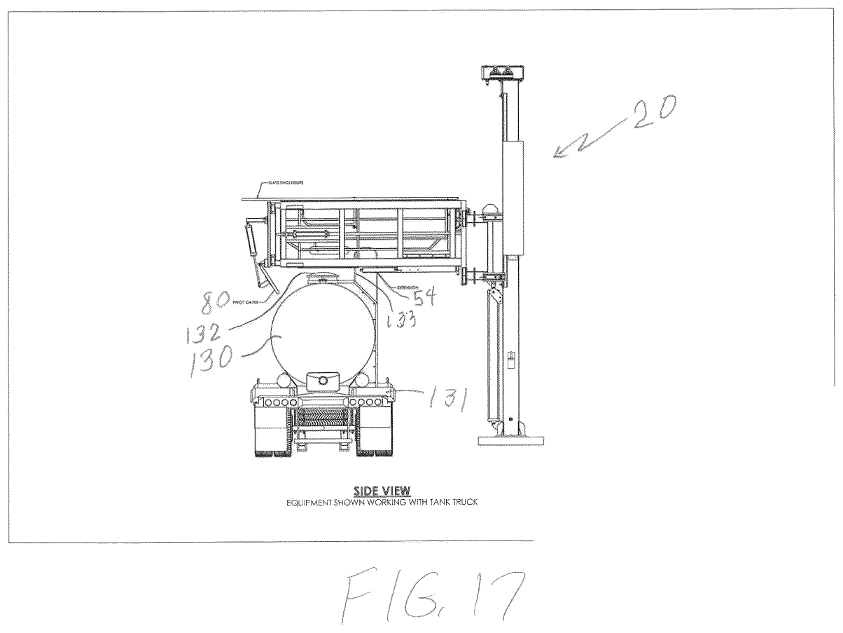

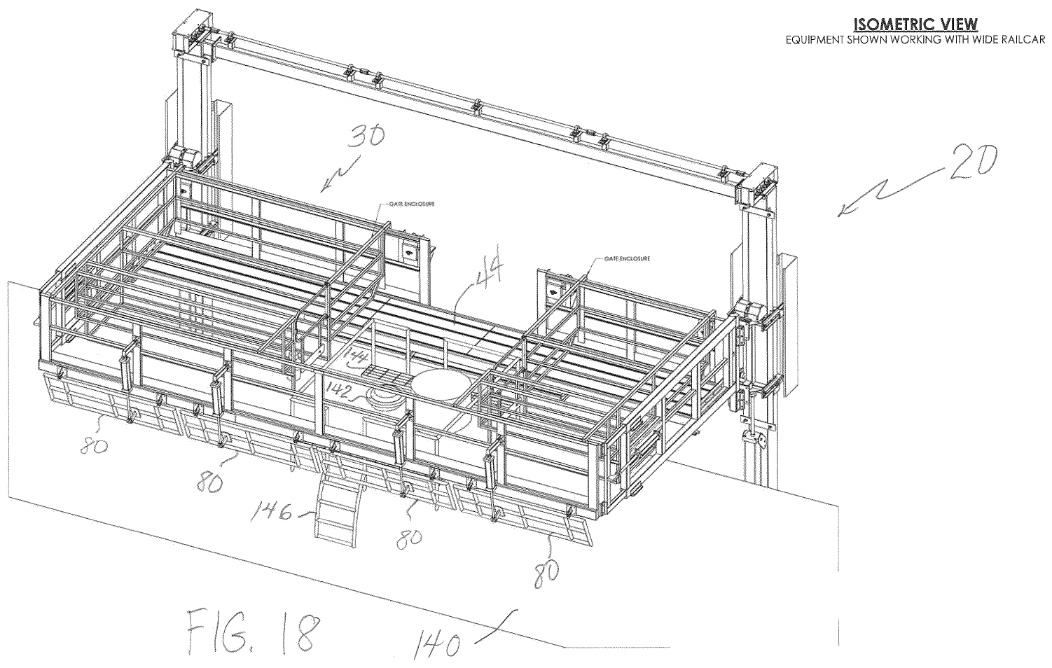

FIGS. 15-17 show different views of an embodiment of the elevating platform 20 in relation to a trailer tank 130 that would be pulled by a truck cab (not shown) for example. FIG. 15 is an elevated isometric view. FIG. 16 is a plan view from above the elevating platform 20. FIG. 17 is an elevation view from a back end of the trailer tank 130 in which the trailer 131 is shown. As shown in FIGS. 15 and 16, the trailer tank 130 includes a generally centrally located loading hatch 132. As shown in FIG. 16, the three individual floor extensions 54 are configured to accommodate the ladder 133 that leads to the flat walking deck 134 that surrounds the loading hatch 132. Each of the front swing gate 98 and the back swing gate 108 is deployed in the closed and locked orientation so as to isolate the central loading hatch 132 from workers walking on the floor 44 across the floor extensions 54 to the walking deck 134 at the top of the trailer tank 130. As shown in FIG. 17, a pivoting fence 80 is deployed to move toward the loading hatch 132 and deter falling through any space between the curved surface of the trailer tank 130 and the pivoting fence 80.

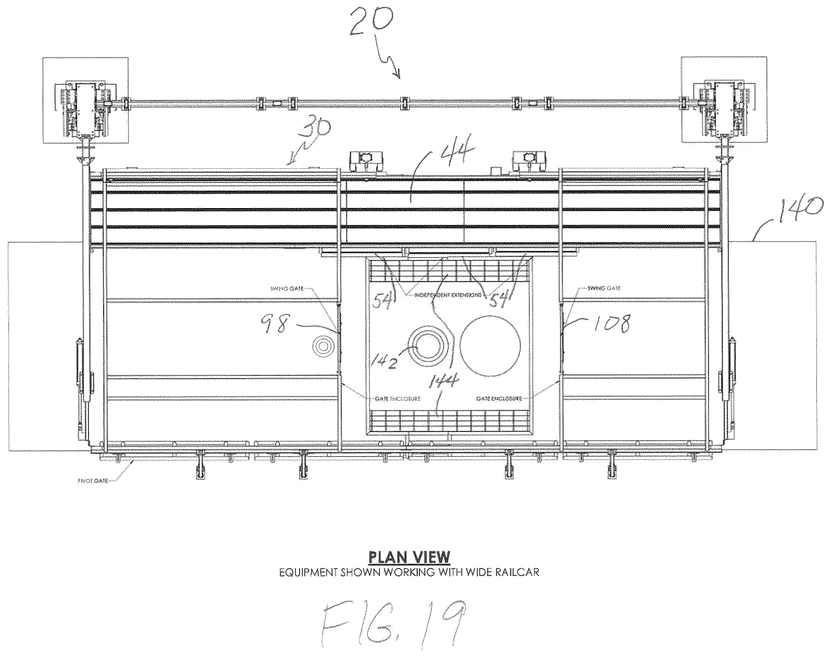

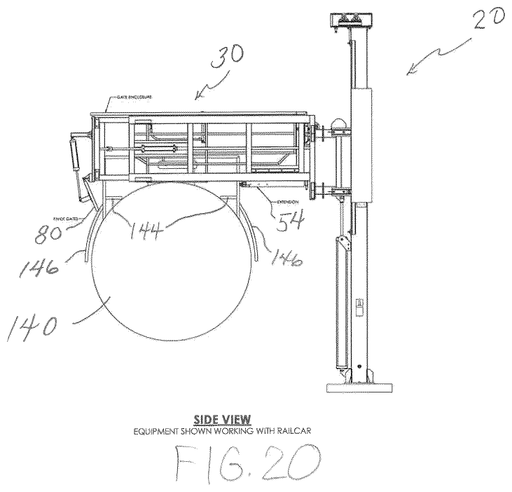

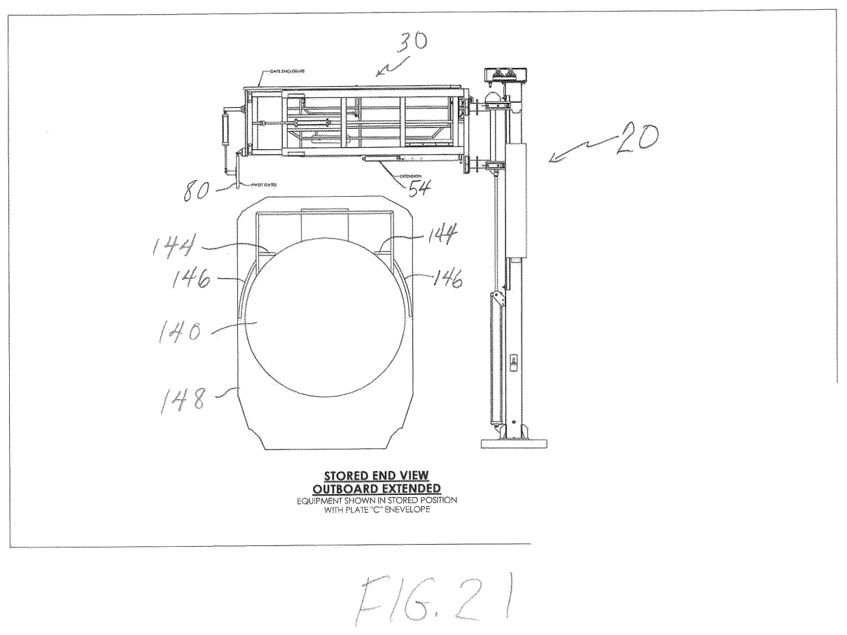

FIGS. 18-21 show different views of an embodiment of the elevating platform 20 in relation to a rail car tank 140 that would be pulled by a truck cab (not shown) for example. FIG. 18 is an elevated isometric view. FIG. 19 is a plan view from above the elevating platform 20. FIG. 20 is an elevation view from a back end of the rail car tank 140 in which the rail car is not shown and the elevating platform 20 is deployed at the top of the rail car tank 140. FIG. 21 is an elevation view similar to FIG. 20 but with the elevating platform 20 deployed raised above the top of the rail car tank 140 and showing the outline 148 of the rail car that is omitted from the drawing for the sake of avoiding undue complexity. As shown in FIGS. 18 and 19, the rail car tank 140 includes a generally centrally located loading hatch 142. A walking deck 144 is disposed to each opposite side of the top of the rail car tank 140. As shown in FIG. 20, the three individual floor extensions 54 are disposed in their retracted orientations to accommodate the ladder 146 that leads to the flat walking deck 144 that straddles the loading hatch 142. Each of the front swing gate 98 and the back swing gate 108 is deployed in the closed and locked orientation so as to isolate the central loading hatch 132 from workers walking on the floor 44 across the floor extensions 54 to the walking deck 134 at the top of the trailer tank 130. As shown in FIGS. 18 and 20, a pivoting fence 80 is deployed to move toward the ladder 146 at the outboard side of the rail car tank 140 to deter workers from falling through any space between the curved surface of the rail car tank 140 and the pivoting fence 80.

What is claimed is:

1. An elevating platform, comprising:
a. a first support stanchion and a second support stanchion disposed spaced apart in a longitudinal direction from the first stanchion, wherein each of the first support stanchion and the second support stanchion extends in a vertical direction that is normal to the longitudinal direction;
b. a lift mechanism coupled to the first support stanchion and the second support stanchion and configured to selectively raise and lower a load in the vertical direction;
C. a base frame carried by the lift mechanism;
d. the base frame defining an inboard side elongating in the longitudinal direction and disposed adjacent the first support stanchion and the second support stanchion, an outboard side spaced apart from the inboard side in a direction away from the first support stanchion and the second support stanchion and elongating in the longitudinal direction, a front end elongating between the inboard side and the outboard side along a transverse direction that is normal to both the longitudinal direction and the vertical direction, a back end elongating between the inboard side and the outboard side and spaced apart from the front end in the longitudinal direction;
e. a floor carried by the base frame and defining a walking surface that elongates from the front end of the base frame to the back end of the base frame, the floor defining an inboard edge disposed adjacent the inboard side of the base frame, the floor defining an outboard edge disposed away from the inboard edge in the transverse direction and disposed spaced away from the outboard side of the base frame, wherein the outboard edge of the floor and the outboard side of the base frame define longitudinally extending borders of an access opening;
f. a plurality of floor extensions, each of the plurality of floor extensions being slidably carried beneath the floor and configured for being selectively extendable to at least partially close the access opening and selectively retractable to open the access opening; and
g. a plurality of floor actuators, wherein a respective one of each of the plurality of floor actuators being coupled to a respective one of each of the plurality of floor extensions, wherein each of the floor actuators being configured for moving a respective one of the plurality of floor extensions between a retracted position disposed beneath the floor and an extended position that at least partially closes the access opening.

2. The elevating platform as in claim 1, further comprising a lateral extender coupled between the outboard side of the base frame and each of the front end of the base frame and the back end of the base frame, wherein the lateral extender is configured for slidable movement with respect to both the front end of the base frame and the back end of the base frame.

3. The elevating platform as in claim 2, further comprising a lateral actuator carried by the base frame and connected to the lateral extender, wherein the lateral actuator is configured for selectively moving the lateral extender between an outboard position, which is disposed away from each of the front end of the base frame and the back end of the base frame, and an inboard position, which is disposed adjacent the front end of the base frame and the back end of the base frame.

4. The elevating platform as in claim 1, further comprising a back fence carried by the outboard side of the base frame, wherein the back fence elongates in the longitudinal direction from the back end of the base frame toward the front end of the base frame, wherein the back fence depends from the outboard side of the base frame in a direction that extends beneath the floor, wherein the back fence is pivotally coupled to the outboard side of the base frame.

5. The elevating platform as in claim 4, further comprising a back fence actuator carried by the outboard side of the base frame, wherein the back fence actuator is configured for selectively moving the back fence between a depending position, in which the back fence is disposed generally vertically from the outboard side of the base frame, and an inboard position, in which the back fence is disposed toward the inboard side of the base frame.

6. The elevating platform as in claim 5, wherein the back fence actuator includes a pressurized cylinder having one end coupled to the outboard side of the base frame and disposed spaced apart from the outboard side of the base frame, wherein the pressurized cylinder includes a piston slidably received within the pressurized cylinder and coupled to a rod having one end pivotally connected to the back fence.

7. The elevating platform as in claim 6, further comprising a front fence carried by the outboard side of the base frame, wherein the front fence elongates in the longitudinal direction from the front end of the base frame toward the back end of the base frame, wherein the front fence depends from the outboard side of the base frame in a direction that extends beneath the floor, wherein the front fence is pivotally coupled to the outboard side of the base frame.

8. The elevating platform as in claim 7, further comprising a front fence actuator carried by the outboard side of the base frame, wherein the front fence actuator is configured for selectively moving the front fence between a depending position, in which the front fence is disposed generally vertically from the outboard side of the base frame, and an inboard position, in which the front fence is disposed toward the inboard side of the base frame.

9. The elevating platform as in claim 5, wherein the front fence actuator includes a pressurized cylinder having one end coupled to the outboard side of the base frame and disposed spaced apart from the outboard side of the base frame, wherein the pressurized cylinder includes a piston slidably received within the piston and coupled to a rod having one end pivotally connected to the front fence.

10. The elevating platform as in claim 9, further comprising a forward middle fence carried by the outboard side of the base frame, wherein the forward middle fence elongates in the longitudinal direction from the front fence toward the back end of the base frame, wherein the forward middle fence depends from the outboard side of the base frame in a direction that extends beneath the floor, wherein the forward middle fence is pivotally coupled to the outboard side of the base frame.

11. The elevating platform as in claim 10, further comprising a forward middle fence actuator carried by the outboard side of the base frame, wherein the forward middle fence actuator is configured for selectively moving the forward middle fence between a depending position, in which the forward middle fence is disposed generally vertically from the outboard side of the base frame, and an inboard position, in which the forward middle fence is disposed toward the inboard side of the base frame.

12. The elevating platform as in claim 11, wherein the forward middle fence actuator includes a pressurized cylinder having one end coupled to the outboard side of the base frame and disposed spaced apart from the outboard side of the base frame, wherein the pressurized cylinder includes a piston slidably received within the piston and coupled to a rod having one end pivotally connected to the forward middle fence.

13. The elevating platform as in claim 12, further comprising a backward middle fence carried by the outboard side of the base frame, wherein the backward middle fence elongates in the longitudinal direction from the back fence toward the forward middle fence, wherein the backward middle fence depends from the outboard side of the base frame in a direction that extends beneath the floor, wherein the backward middle fence is pivotally coupled to the outboard side of the base frame.

14. The elevating platform as in claim 13, further comprising a backward middle fence actuator carried by the outboard side of the base frame, wherein the backward middle fence actuator is configured for selectively moving the backward middle fence between a depending position, in which the backward middle fence is disposed generally vertically from the outboard side of the base frame, and an inboard position, in which the backward middle fence is disposed toward the inboard side of the base frame.

15. The elevating platform as in claim 14, wherein the backward middle fence actuator includes a pressurized cylinder having one end coupled to the outboard side of the base frame and disposed spaced apart from the outboard side of the base frame, wherein the pressurized cylinder includes a piston slidably received within the piston and coupled to a rod having one end pivotally connected to the backward middle fence.

16. The elevating platform as in claim 1, further comprising a front cage defining an interior thereof, wherein the front cage is disposed between the front end of the base frame and the access opening and carried by the base frame, wherein the front cage includes a front gate coupled to the front cage and facing the access opening, wherein the front gate is configured and disposed to control worker access between the interior of the front cage and the access opening.

17. The elevating platform as in claim 1, further comprising a back cage defining an interior thereof, wherein the back cage is disposed between the back end of the base frame and the access opening and carried by the base frame, wherein the back cage includes a back gate coupled to the back cage and facing the access opening, wherein the back gate is configured and disposed to control worker access between the interior of the back cage and the access opening.

18. The elevating platform as in claim 15, wherein a said actuating mechanism comprises a pneumatic actuator.

19. The elevating platform as in claim 17, wherein said actuating mechanism comprises a linkage connected to a stationary object.
